(19) United States
(12) Patent Application Publication
(10) Pub. No.: US 2017/0228523 A1
(43) Pub. Date: Aug. 10, 2017

(54) METHOD AND APPARATUS FOR ANALYZING RELATION BETWEEN DRUG AND PROTEIN

(71) Applicant: INDUSTRY-ACADEMIC COOPERATION FOUNDATION, YONSEI UNIVERSITY, Seoul (KR)

(72) Inventors: Sang Hyun PARK, Seoul (KR); Yun Ku YEU, Seoul (KR); Young Mi YOON, Seongnam (KR)

(21) Appl. No.: 15/154,519

(22) Filed: May 13, 2016

(30) Foreign Application Priority Data
Feb. 4, 2016 (KR) 10-2016-0013960

(51) Int. Cl. G06F 19/00; G06N 99/00

(52) U.S. Cl. CPC G06F 19/707; G06N 99/005

(57) ABSTRACT

Provided are a method and an apparatus for analyzing a relation between a drug and a protein. Further, the present invention relates to drug repositioning. The method for analyzing a relation between a drug and a protein may include a protein location information inputting step of receiving protein location information representing a location where the protein included in a training data set is present in a cell, with regard to the training data set including at least one combination data of the drug and the protein having interrelation; and a classifier training step of training the classifier for determining a correlation between the drug and the protein by using the training data set based on protein feature information of the protein including the protein location information and drug feature information of the drug.

### CROSS-REFERENCE TO RELATED APPLICATIONS

This application claims priority to and the benefit of Korean Patent Application No. 10-2016-0013960 filed in the Korean Intellectual Property Office on Feb. 4, 2016, the entire contents of which are incorporated herein by reference.

### TECHNICAL FIELD

The present invention relates to a method and an apparatus for analyzing a relation between a drug and a protein. Further, the present invention relates to drug repositioning.

### BACKGROUND ART

In a drug repositioning study for searching a new use of an existing drug, a relation between a new drug and a target is predicted based on similarity between drugs or similarity between target proteins affected by the drug. For example, whether another drug having a similar property to a drug which has an effect on any disease is applied to the corresponding disease or any drug has an effect on another protein having a similar property to the target protein may be experimented.

Particularly, recently, cases of using a bioinformatics approach method to the drug repositioning study have been increased. The bioinformatics approach method is an approach method of setting a drug-target protein hypothesis estimated when a correlation is high, by maximally considering usable biological information. As such, a method of predicting an available candidate group by using the approach method of the bioinformatics is a very important study tool capable of largely reducing costs for new-drug development and has been widely used in a new-drug development process. However, in a method of analyzing the relation between the drug and the protein based on the existing bioinformatics approach method, used information is limited and thus there is a limitation on reliability of the relation analysis between the drug and the target protein.

### SUMMARY OF THE INVENTION

The present invention has been made in an effort to provide a method for analyzing a relation between a drug and a protein having an advantage of more accurately and reliably determining a correlation between the drug and the protein.

An exemplary embodiment of the present invention provides a method for analyzing a relation between a drug and a protein including: a protein location information inputting step of receiving a protein location information representing a location where the protein included in a training data set is present in a cell, with regard to the training data set including at least one combination data of the drug and the protein having interrelation; and a classifier training step of training the classifier for determining a correlation between the drug and the protein by using the training data set based on protein feature information of the protein including the protein location information and drug feature information of the drug.

The classifier may be a classifier that determines the correlation between the protein and the drug by inputting the protein feature information of the protein and the drug feature information of the drug.

The method for analyzing the relation between the drug and the protein may further include a protein location information updating step based on the protein-protein interaction network of updating the protein location information of the protein included in the training data set by using the protein-protein interaction network representing the relation between the proteins,

In the classifier training step, the classifier may be trained based on the protein feature information according to the updated protein location information.

The protein location information may include a protein location information vector representing whether the protein is present in at least one predetermined representative location in a cell.

The representative location may include at least one of cytosol, endoplasmic reticulum, extracellular, Golgi, peroxisome, mitochondria, nucleus, lysosome, and plasma membrane.

The protein feature information may include at least one of amino acid sequence information of the protein and location information on the protein-protein interaction network, together with the protein location information.

The drug feature information may include at least one of chemical structure information of the drug and side-effect information of the drug.

The classifier training step may comprise: a set setting step of setting a test set and a training set in the training data set; a selecting step of selecting combination data of the drug and the protein having a predetermined level or more of correlation with the combination data of the drug and the protein included in the test set from the combination data of the drug and the protein included in the training set, for each combination data of the drug and the protein included in the test set; and a classifier parameter training step of training a parameter of the classifier based on the protein feature information and the drug feature information of each of the combination data of the drug and the protein selected in the training set and the combination data of the drug and the protein included in the test set.

In the set setting step, the training data set may be divided into a predetermined number of partial sets and some of the divided partial sets may be set to the test set and the remaining partial sets except for the test set may be set to the training set.

The selecting step may comprise: a drug-drug similarity calculating step of calculating the similarity between the drug feature information of the combination data of the drug and the protein included in the test set and the drug feature information of the combination data of the drug and the protein included in the training set; a protein-protein similarity calculating step of calculating the similarity between the protein feature information of the combination data of the drug and the protein included in the test set and the protein feature information of the combination data of the drug and the protein included in the training set; a correlation calculating step of calculating the correlation by using the calculated similarity between the drug feature information and the similarity between the protein feature information; and a selecting step of selecting the combination data of the drug and the protein based on the calculated correlation. In the classifier parameter training step, the classifier including the partial classifiers may be trained by training the partial classifiers having the number of test sets set in the set setting step by using the test set and the training set.

In the protein location information updating step based on the protein-protein interaction network, the protein location information of the protein of the protein-protein interaction network may be updated by using and calculating the protein location information of adjacent proteins connected to the protein in the protein-protein interaction network.

In the protein location information updating step based on the protein-protein interaction network, the protein location information of the protein of which the protein location information is set in the early stages may be maintained in the protein-protein interaction network, and the protein location information of the protein of which the protein location information is not set in the early stages may be set as the protein location information calculated by using the adjacent protein.

Another exemplary embodiment of the present invention provides a method for analyzing a relation between a drug and a protein, comprising: a drug-protein feature information inputting step of receiving the drug feature information of the drug and the protein feature information of the protein, with respect to the drug and the protein to determine a correlation; and a correlation determining step of determining the correlation between the drug and the protein based on the drug feature information and the protein feature information using the pre-trained classifier.

Herein, the protein feature information may include protein location information representing a location where the protein is present in a cell.

The protein location information may include a protein location information vector representing whether the protein is present in at least one predetermined representative location in a cell.

The protein feature information may include at least one of amino acid sequence information of the protein and location information on the protein-protein interaction network, together with the protein location information.

The drug feature information may include at least one of chemical structure information of the drug and side-effect information of the drug.

The correlation determining step may include: a selecting step of selecting combination data between the drug and the protein to determine the correlation and combination data between the drug and the protein having a predetermined level or more of correlation, in a correct set including combination data between a drug and a protein which are previously known to have the correlation; and a determining step of determining the correlation between the drug and the protein by using the classifier based on the protein feature information and the drug feature information of each of the combination data between the drug and the protein selected in the correct set and the combination data between the drug and the protein to determine the correlation.

Yet another exemplary embodiment of the present invention provides an apparatus for analyzing a relation between a drug and a protein comprising: a protein location information inputting unit of receiving a protein location information representing a location where the protein included in a training data set is present in a cell, with regard to the training data set including at least one combination data of the drug and the protein having interrelation; and a classifier training unit of training the classifier for determining a correlation between the drug and the protein by using the training data set based on protein feature information of the protein including the protein location information and drug feature information of the drug.

Still another exemplary embodiment of the present invention provides an apparatus for analyzing a relation between a drug and a protein, including: a drug-protein feature information inputting unit of receiving the drug feature information of the drug and the protein feature information of the protein, with respect to the drug and the protein to determine a correlation; and a correlation determining unit of determining the correlation between the drug and the protein based on the drug feature information and the protein feature information using the pre-trained classifier.

Herein, the protein feature information may include protein location information representing a location where the protein is present in a cell.

The correlation determining unit may include: a selecting unit of selecting combination data between the drug and the protein to determine the correlation and combination data between the drug and the protein having a predetermined level or more of correlation, in a correct set including combination data between a drug and a protein which are previously known to have the correlation; and a determining unit of determining the correlation between the drug and the protein by using the classifier based on the protein feature information and the drug feature information of each of the combination data between the drug and the protein selected in the correct set and the combination data between the drug and the protein to determine the correlation.

According to the exemplary embodiment of the present invention, it is possible to increase accuracy of a relation analysis between a drug and a protein. Further, it is possible to enhance the efficacy of new drug development and shorten a development time through drug repositioning using the analyzing method according to the present invention.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flowchart of a method for analyzing a relation between a drug and a protein according to an exemplary embodiment of the present invention.

FIG. 2 is a flowchart of a method for analyzing a relation between a drug and a protein according to another exemplary embodiment of the present invention.

FIG. 3 is a reference diagram illustrating a result in which a protein positional information value is propagated and updated from a protein interaction network.

FIG. 4 is a detailed flowchart of a classifier training step (S200).

FIG. 5 is a detailed flowchart of a selecting step (S220).

FIG. 6 is a flowchart of a method for analyzing a relation between a drug and a protein according to yet another exemplary embodiment of the present invention.

FIG. 7 is a detailed flowchart of a correlation determining step (S2000).

FIG. 8 is a block diagram of an apparatus for analyzing a relation between a drug and a protein according to still another exemplary embodiment of the present invention.

FIG. 9 is a block diagram of an apparatus for analyzing a relation between a drug and a protein according to still yet another exemplary embodiment of the present invention.

FIG. 10 is a detailed block diagram of a correlation determining unit 2000.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

Drug positioning is one of research methods for reducing the risk of new drug development. According to studies for analyzing drug development trends from 2000 to 2008 by Pammolli and the like, a probability of success of a new material up to a clinical trial is approximately 2.01% and a period of an average of 13.9 years is required in drug development.

In order to overcome the limitation, drug repositioning for searching a new use of the existing drug has been studied. To this end, based on similarity between the drugs or similarity between target proteins applied with the drug, it is required to predict a relation between a new drug and a target. For example, whether another drug having a similar property to a drug which has an effect on any disease is applied to the corresponding disease or any drug has an effect on another protein having a similar property to the target protein may be tested.

Recently, cases of using a bioinformatics approach method for the drug repositioning study have been increased. The bioinformatics approach method is an approach method of setting a drug-target protein hypothesis estimated when the correlation is high, by maximally considering usable biological information. As such, a method of predicting an available candidate group by using the approach method of the bioinformatics is a very important study tool capable of largely reducing costs for new-drug development and has been widely used in a new-drug development process. Particularly, when there is a limitation due to budget for spending on the development of new drugs like rare diseases or diseases of which study costs are expensive, the bioinformatics approach method may be usefully utilized to study the drugs.

For example, Gottlieb and the like compared and analyzed similarity between drugs by using a chemical structure of the drug, side-effect information, amino acid sequences, a distance from a protein-protein interaction network, and the like (Gottlieb, Assaf, et al. “PREDICT: a method for inferring novel drug indications with application to personalized medicine.” Molecular systems biology, vol. 7, no. 1, 2011.).

However, in a method of analyzing the relation between the drug and the protein based on the existing bioinformatics approach method, used information is limited and thus there is a limitation on reliability of the relation analysis between the drug and the target protein.

Therefore, the present invention has been made in an effort to provide a method for analyzing a relation between a drug and a protein capable of more accurately and reliably determining a correlation between the drug and the protein.

To this end, in the present invention, location information of the protein is utilized as an important prediction feature to determine a feature of the drug. The location information of the protein means a location in a cell to which the protein is applied. A lot of proteins have specific action locations, and when the action location is similar, there is a possibility that the function thereof is also similar. The location information of the protein has been utilized to study the comorbidity between diseases, but has not yet been utilized in the repositioning study of the drug. Accordingly, the present invention provides a method for analyzing a relation between a protein and a drug by utilizing the location information of the protein.

Hereinafter, a method for analyzing a relation between a drug and a protein and an apparatus for the same according to the present invention will be described in more detail.

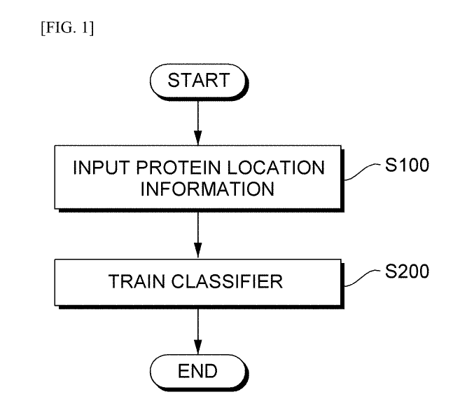

FIG. 1 is a flowchart of a method for analyzing a relation between a drug and a protein according to an exemplary embodiment of the present invention.

The method for analyzing the relation between the drug and the protein according to an exemplary embodiment of the present invention may include a protein location information inputting step (S100) and a classifier training step (S200). The method for analyzing the relation between the drug and the protein according to the exemplary embodiment relates to a method of training the classifier used for analyzing the relation between the drug and the protein.

In the protein location information inputting step (S100), the protein location information representing a location where the protein included in a training data set is present in a cell is inputted, with regard to the training data set including at least one combination data of the drug and the protein having interrelation.

In the classifier training step (S200), the classifier for determining a correlation between the drug and the protein is trained by using the training data set based on protein feature information of the protein including the protein location information and drug feature information of the drug.

Herein, a method for analyzing a relation between a drug and a protein according to another exemplary embodiment of the present invention may further include updating the protein location information based on a protein-protein interaction network (S150).

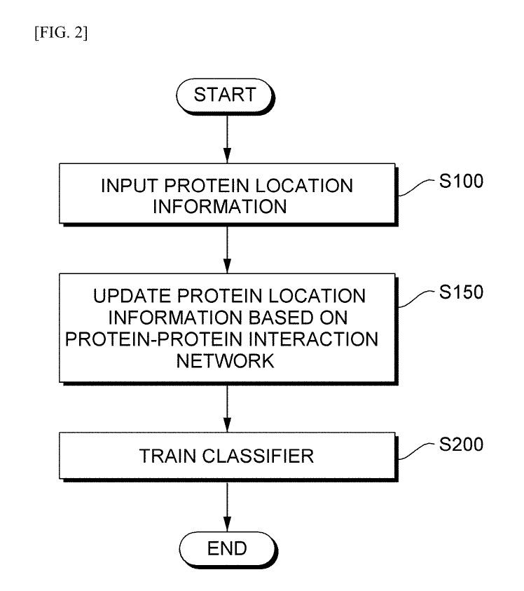

FIG. 2 is a flowchart of the method for analyzing the relation between the drug and the protein according to the exemplary embodiment.

In the protein location information updating step based on the protein-protein interaction network (S150), the protein location information of the protein included in the training data set is updated by using the protein-protein interaction network representing the relation between the proteins.

In this case, in the classifier training step (S200), the classifier based on the protein feature information may be trained according to the updated protein location information.

Next, a detailed operation of each step of the method for analyzing the relation between the drug and the protein according to the present invention will be described in more detail.

First, the protein location information inputting step (S100) will be described in more detail.

In the protein location information inputting step (S100), the protein location information representing a location where the protein included in a training data set is present in a cell is inputted, with regard to the training data set including at least one combination data of the drug and the protein having interrelation.

Herein, the training data set is a data set including previously known combination data which has a correlation between a specific drug and a specific protein. Information on the correlation between the drug and the target protein may be acquired from a database such as Drugbank which includes for example, drug identification information and target protein information of the drug. As such, the training data set may be a data set including information on the correlation between the drug and the protein which is acquired through an experiment or represented in an existing experiment result.

Herein, the protein included in the training data set may include the protein location information. Herein, the protein location information may include information on a location where the protein is present and acts in a cell. The protein location information may receive the acquired information through the experiment or receive the information acquired from the existing experiment result. For example, the protein location information may be acquired from a database such as UniProt including the protein identification information and intracellular location information.

In this case, the protein location information may include a protein location information vector representing whether the protein is present in at least one predetermined representative location in the cell. Herein, the representative location may include at least one of for example, cytosol, endoplasmic reticulum (ER), extracellular, Golgi, peroxisome, mitochondria, nucleus, lysosome, plasma membrane, or other locations. Alternatively, if necessary, another intracellular location may also be set as a representative location.

Herein, the protein location information vector may be a vector of which an element value is set as a predetermined first value when the protein is present at the representative location and the element value is set as a predetermined second value when the protein is not present at the representative location. Herein, it is preferred that the element value of the vector corresponding to the predetermined representative location when the protein is present at the predetermined representative location is set to be larger than the element value when the protein is not present at the specific representative location.

Herein, when the representative locations are selected as a total of 10 places such as for example, the cytosol, the endoplasmic reticulum (ER), the extracellular, the Golgi, the peroxisome, the mitochondria, the nucleus, the lysosome, the plasma membrane, or other locations as described above, the protein location information vector may be a vector of which a length in which the vector element value is set to 0 or 1 is 10 according to whether the protein is present at each representative location. This is a case where the first value is 1 and the second value is 0, and herein, if necessary, of course, the first and second values may be set to different values.

For example, when the value of each element of the protein location information vector having the length of 10 is set in order of the aforementioned representative location, the protein location information vector v may be expressed as [1, 0, 0, 0, 0, 0, 1, 0, 0, 0] when a protein having a protein ID of P31946 is present at the cytosol and the nucleus in the cell.

In the protein location information inputting step (S100), the protein location information of the protein included in the training data set is inputted. Herein, receiving the information in the protein location information inputting step (S100) is a concept including all operations of reading the stored protein location information from a memory or a storage device or a server or a database connected to a network, and a concept including a series of operations of receiving the protein location information in which other processors or a signal processing module or a hardware device is stored in the storage.

Next, the protein location information updating step based on the protein-protein interaction network (S150) will be described in more detail.

In the protein location information updating step based on the protein-protein interaction network (S150), the protein location information of the protein included in the training data set is updated by using the protein-protein interaction network representing the relation between the proteins.

Herein, the protein-protein interaction (PPI) network is to express the interaction between the proteins in a network form and represents a relation in which the proteins are physically bonded with each other. Herein, the PPI network may be expressed in a form in which the proteins are expressed as nodes and the proteins having a mutual bonding relation are connected to each other by edges. Herein, the PPI network may be generated or acquired based on a database such as UniProt or BioGrid including information on an existing protein-protein interaction. In addition, of course, the PPI network may be generated according to the information acquired through another experiment result.

Herein, according to reliability of the database used to generate the PPI network, a weight value of a connection edge between nodes may be differently set. For example, since the UniProt is experimentally verified data and may expect higher accuracy, the edge generated based on the UniProt may grant a weight value higher than the edge generated based on the BioGrid data.

In the location information updating step based on the PPI network, as described above, the predetermined PPI network may be inputted and the corresponding protein location information may be granted to each node of the PPI network. In this case, nodes in which the protein location information is not granted because the information on the intracellular location of the protein is not previously known may be present among nodes of the PPI network. As a result, in the location information updating step based on the PPI network, the protein location information of the nodes without the granted protein location information may be calculated by using the nodes with the granted protein location information.

To this end, in the protein location information updating step based on the PPI network (S150), the protein location information of the protein of the PPI network may be calculated by using the protein location information of an adjacent protein connected to the protein in the PPI network. In addition, the protein location information of the protein node may be continuously updated while repeating the process multiple times.

Herein, in the protein location information updating step based on the PPI network (S150), the protein location information of the specific protein node may be updated to a value obtained by calculating protein location information values of the adjacent protein nodes. Herein, the calculation may be an operation calculating an average and a weighted sum operation, and if necessary, may be defined as another operation function.

For example, in the protein location information updating step based on the PPI network (S150), the protein location information value of the protein node may be updated in the network through an operation as the following Equation 1. Herein, the protein location information value may be the aforementioned protein location information vector.

vₜ₊₁=αf(vₜ,LV_{N})+(1+α)v₀ [Equation 1]

Herein, vₜ is an updated protein location information value of the protein node, LV_{N} is a set of the protein location information of the adjacent protein nodes (LV_{N}={lv₁, . . . lv_{M}}, M is the number of adjacent protein nodes, and lv is protein location information of adjacent protein nodes), v0 is an initial value of the updated protein node, α is a weighted value, and t is an index representing the number of updating times. Herein, f( ) is an operation function which may be defined if necessary and for example, may be defined as a weighted sum operation function, an average operation function, and the like. For example, f( ) may be defined as

$${\sum }_{m = 1}^{M} {w}_{( {v}_{t} ∼ {lv}_{m} )} {•lv}_{m} .$$

Herein, w₍ᵥ_{ₜ}_{˜lv}_{ₘ}₎ is a weighted value of an edge between a protein node corresponding to vt and an adjacent protein node corresponding to lvm.

Herein, the protein location information value of the protein node may be updated many times and repeated until a predetermined number of times or a predetermined convergence condition is satisfied. For example, until the condition like the following Equation 2 is satisfied, the protein location information value of the protein node of the PPI network may be updated.

$$\vert {\sum }_{{v}_{t} ∈ {NN}_{t}} {norm}_{max} ( {v}_{t} ) - {\sum }_{{v}_{t + 1} ∈ {NN}_{t + 1}} {norm}_{max} ( {v}_{t + 1} ) \vert < K \qquad [ Equation 2 ]$$

Herein, NNₜ is a set of nodes included in the network in a t-th updating, and normₘₐₓ is a function of outputting a value having the largest norm value among element values of the protein location information vector. Further, K may be set as a constant set for limiting the convergence degree if necessary. For example, K may be set to 10⁻⁶.

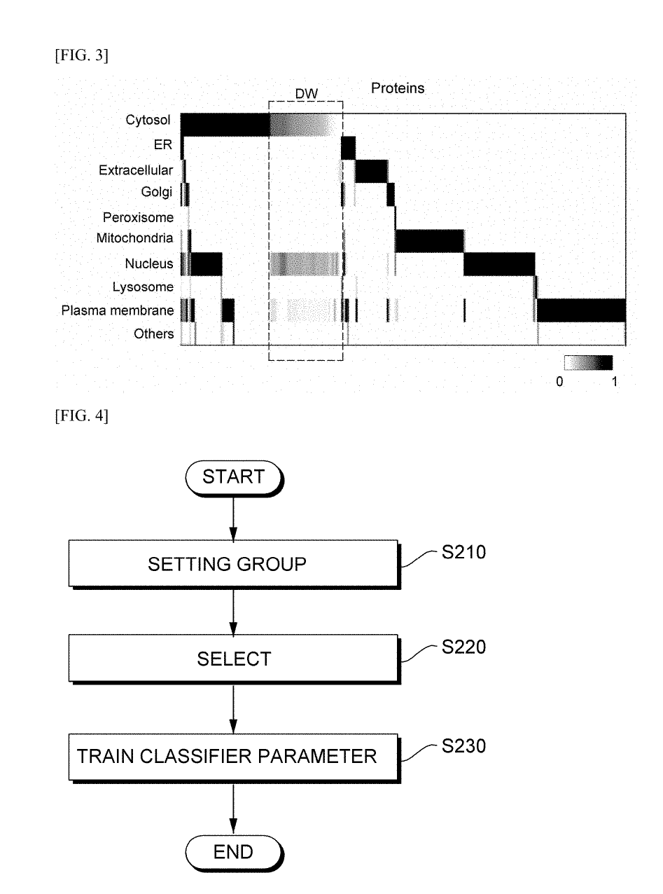

FIG. 3 is a reference diagram illustrating a result in which the protein location information value is set up to the nodes which do not know the value of the protein location information among the nodes of the PPI network though the process described above.

In FIG. 3, a Y axis is to list the proteins for each index, an X axis expresses each element of the protein location information vector, and a value expressed by the contrast from white to black in a graph is each element value of each protein location information vector. In FIG. 3, if the protein is present at a specific representative location, the value is expressed by 1 (black), and if not, the value is expressed by 0 (white). In FIG. 3, portions specified by a dotted window are proteins which may not set the protein location information vector because the protein location information is not determined in the early stages, and proteins allocated with values obtained by calculating the protein location information value through the aforementioned process.

As such, in the PPI network in which the protein location information value is updated, it is meant that as the element value of the protein location information vector is increased, a possibility that the protein is present at a representative location corresponding to the element of the vector is large.

Herein, in the protein location information updating step based on the PPI network (S150), in the PPI network, the protein location information of the protein of which the protein location information is set in the early stages is maintained, and the protein location information of the protein of which the protein location information is not set in the early stages may be set to the protein location information calculated by using the adjacent protein. That is, with respect to the protein nodes of which the protein location information values are known in advance, the corresponding protein location information is maintained as it is, and with respect to the protein nodes of which the protein location information values are not known, the protein location information value calculated through the aforementioned updating process may be set to the protein location information value of the corresponding protein node.

Next, the classifier training step (S200) will be described in more detail. In the classifier training step (S200), the classifier for determining a correlation between the drug and the protein is trained by using the training data set based on protein feature information of the protein including the protein location information and drug feature information of the drug. Herein, as described above, when the protein location information updating step based on the PPI network (S150) is included, in the classifier training step (S200), the classifier may be trained based on the protein feature information according to the updated protein location information.

Herein, the classifier is a classifier which determines a correlation between the protein and the drug by inputting the protein feature information of the protein and the drug feature information of the drug. Herein, the correlation may be an index which represents whether the specific drug and the protein have a correlation or not as TRUE or FALSE. Alternatively, if necessary, the correlation may be an index expressed by a value having a predetermined range representing the correlation between the specific drug and the protein. Herein, the classifier may also output the correlation as a value of 1 (there is a correlation) or 0 (there is no correlation) according to an operation of a classification function of the classifier, or output the correlation to have a larger value as the correlation is increased in a range of 0 to 1.

Herein, the classifier may be a classifier trained by using a machine training algorithm and use the protein feature information and the drug feature information as a feature used for the operation of the classifier.

Herein, the protein feature information may include at least one of amino acid sequence information of the protein and location information on the PPI network, together with the protein location information.

The drug feature information may include at least one of chemical structure information of the drug and side-effect information of the drug. Herein, the chemical structure information of the drug may use, for example, structure information defined according to a simplified molecular-input line-entry system (SMILES) as the chemical structure information of the drug. The SMILES is a specification method in which the chemical structure information including constituent elements of chemical materials, bond types, aromaticity, branches or not, and the like is expressed by strings of ASCII codes. Alternatively, the side-effect information of the drug may be collected in a database such as, for example, SIDER2. Since the side effect of the drug is also indirectly related with the function and the action of the drug, the side-effect information may be used as one of the drug feature information.

Herein, the amino acid sequence information of the protein and the location information in the PPI network in the protein feature information and the chemical structure information of the drug and the side-effect information of the drug in the drug feature information may use the chemical structure and side-effect information of the drug, the amino acid sequence of the protein, the location information in the PPI network which are features used in the existing studies, as the protein feature information and the drug feature information in the classifier according to the present invention. The amino acid sequence information of the protein and the location information of the protein in the protein feature information may be collected in a protein database such as Drugbank. Like a homology protein, when the amino acid sequence is similar, the function also tends to be similar, and it is known that a short amino acid sequence such as a motif is associated with a protein function. The location information of the protein represents locations of intracellular organelles where the protein performs the function and is closely associated with the function of the protein. For example, in the case of the protein having the cell membrane as the location information, a possibility to have a function associated with a material exchange between the inside and the outside of the cells is higher than another function. The location information in the PPI network represents a shortest distance between two proteins on the PPI network. The protein does not perform the function alone, but tends to perform the function by configuring a protein complex obtained by binding several proteins. The data representing a physical binding relation between the proteins is protein interaction data.

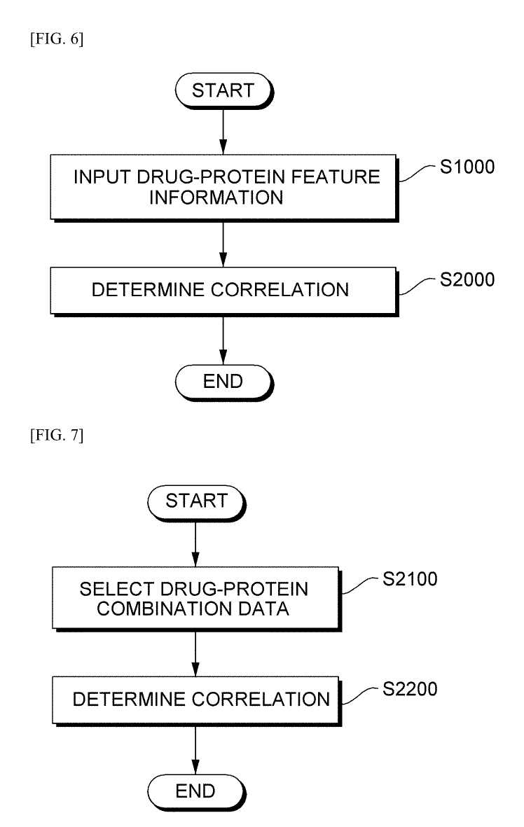

Herein, when the classifier receives the protein feature information and the drug feature information described above to determine the correlation between the drug and the protein, as described in detail in the correlation determining step (S2000) to be described below with reference to FIG. 6, drug feature information and protein feature information for a target drug and a protein to determine the correlation, and drug feature information and protein feature information of combination data of a drug and a protein which are selected to have a predetermined level or more of correlation between the target drug and the protein in the combination data of the drug and the protein included in a correct set known previously to have the correlation may be used as the input information. Alternatively, the classifier may calculate similarity for each feature information between the drug feature information and the protein feature information for the target drug and the protein and the drug feature information and the protein feature information of the selected combination data of the drug and the protein and determine a correlation between the target drug and the protein by inputting the calculated similarity to the classifier.

Next, an operation of the classifier training step (S200) of training the classifier will be described in more detail.

FIG. 4 is a detailed flowchart of the classifier training step (S200).

The classifier training step (S200) may include a set setting step (S210), a selecting step (S220), and a classifier parameter training step (S230).

In the set setting step (S210), a training set is set in the training data set. The training set is a set of data used for training the parameters of the classifier. Further, in the set setting step (S210), a test set for testing the trained classifier may be set. Herein, the training data set is a set including combination data between the drug and the protein which are previously known to have the correlation in advance as described above. In the set setting step (S210), for training the classifier, in the training data set, the test set and the training set may be set.

In an exemplary embodiment of the present invention, in the classifier training step (S200), the classifier may be trained by using a cross validation method and if necessary, a k-fold cross validation method of setting a plurality of test sets and training sets may also be used. In the classifier training step (S200), of course, the classifier may be trained by using the combination data of the drug and the protein included in the training data set by using another training method other than the cross validation method. Further, in the case of using the cross validation method, of course, another cross validation method other than the k-fold cross validation method may be used.

Herein, in the set setting step (S210), the training data set is divided into a predetermined number of partial sets and some of the divided partial sets are set to the test set and the remaining partial sets except for the test set may be set to the training set. For example, in the set setting step (S210), the training data set is divided into K partial sets, and each partial set is set to the test set and the remaining partial sets may be set to the training set. In this case, K combinations of the partial sets and the training set may be generated.

In the selecting step (S220), for each combination data of the drug and the protein included in the test set, the combination data of the drug and the protein having a predetermined level or more of correlation with the combination data of the drug and the protein included in the test set is selected from the combination data of the drug and the protein included in the training set. That is, with respect to each combination data of the drug and the protein included in the test set, at least one combination data having a predetermined level or more of correlation may be selected in the training set from the combination data of the drug and the protein included in the training set.

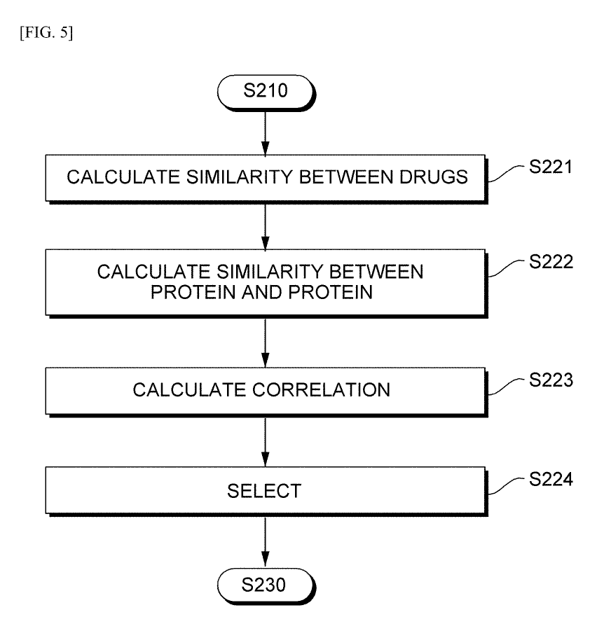

FIG. 5 is a detailed flowchart of the selecting step (S220).

The selecting step (S220) may include a drug-drug similarity calculating step (S221), a protein-protein similarity calculating step (S222), a correlation calculating step (S223), and a selecting step (S224).

In the drug-drug similarity calculating step (S221), the similarity between the drug feature information of the combination data of the drug and the protein included in the test set and the drug feature information of the combination data of the drug and the protein included in the training set is calculated. That is, the drug-drug similarity is calculated between the combination data of the test set and the combination data of the training set, and in this case, the drug-drug similarity may be similarity between drug feature information. In addition, the similarity between drug feature information may be calculated by using at least one of the similarity between the chemical structure information of the drugs and the similarity between the side-effect information of the drugs. Herein, the method of calculating the similarity between the chemical structure information of the drugs and the similarity between the side-effect information of the drugs may use known methods. For example, a chemical fingerprint may be extracted from SMILES strings of the drug by using a chemical structure analysis program such as a chemical development kit (CDK). The similarity of the drugs may be measured by using the similarity between the chemical fingerprints, and the method of measuring the similarity therefor may use, for example, a method of comparing similarity such as Jaccard score. In the case of the side-effect information of the drug, the similarity may be measured based on the number of common side effects of the two drugs. Even in this case, for example, the method of comparing similarity such as Jaccard score may be used.

Herein, the similarity between the drug feature information may be calculated by calculating similarities calculated for each information used as the feature information, that is, the chemical structure information of the drug and the side-effect information of the drug. For example, the similarity between the drug feature information may be calculated by adding all of the similarities calculated for each information used as the feature information or calculating an average.

In the protein-protein similarity calculating step (S222), the similarity between the protein feature information of the combination data of the drug and the protein included in the test set and the protein feature information of the combination data of the drug and the protein included in the training set is calculated. That is, the protein-protein similarity is calculated between the combination data of the test set and the combination data of the training set, and in this case, the protein-protein similarity may be the similarity between the protein feature information. Herein, the similarity between the protein feature information may be calculated by using at least one of the similarities between the protein location information, the similarity between the amino acid sequence information of the protein, and the similarity between the location information on the PPI network. Herein, the method of calculating the similarity between the protein location information, the similarity between the amino acid sequence information of the protein, and the similarity between the location information on the PPI network may use known methods. For example, the similarity between the amino acid sequence information of the protein may use a score calculated through a sequence alignment algorithm such as a smith-waterman algorithm.

For example, the similarity between the protein location information may be calculated by using the protein location information vector. For example, the similarity between the protein location information may be measured by calculating cosine similarity between protein location information vectors. In the case of the cosine similarity, when two protein location vectors are perpendicular to each other in a vector space, a result value is 0 and when directions in the vector space of the locations vectors are completely the same as each other, the result value is 1. The perpendicularity corresponds to a case where there is no intracellular location information having both the location vectors of the two proteins.

For example, the similarity between the location information on the PPI network may be calculated by a distance between the protein nodes. That is, the similarity may be calculated by a distance between the nodes on the network. A possibility that the function is performed by binding adjacent proteins in the PPI network constituted by using the protein interaction information with each other is high, and a possibility that the proteins which are close to each other on the network constitute a protein complex is high. Accordingly, the shortest distance on the PPI network may be used as indirect information representing the similarity in function between the two proteins.

Herein, the similarity between the protein feature information may be calculated by calculating the similarities calculated for each information used as the feature information, that is, the protein location information, the amino acid sequence information of the protein, and the location information on the PPI network. For example, the similarity between the protein feature information may be calculated by adding all of the similarities calculated for each information used as the feature information or calculating an average.

In the correlation calculating step (S223), the correlation is calculated by using the calculated similarity between the drug feature information and the similarity between the protein feature information. Herein, the correlation as an index representing a degree associated with the combination data may be a value calculated by calculating the similarity between the drug feature information and the similarity between the protein feature information. In this case, as an operational function calculating the correlation, various functions in which values are changed according to a size of the two similarity values may be set.

For example, the correlation operational function may be a function outputting a square root of a multiple of two similarities. That is, the correlation operational function may be calculated like the following Equation 3.

S(d′,p′)=\sqrt{sim(d,d′)×sim(p,p′)} [Equation 3]

Herein, d is a drug of the training set, p is a protein of the training set, d′ is a drug of the test set, p′ is a protein of the test set, sim is a function calculating the similarity between the feature information, and S is the correlation.

Herein, as the correlation operational function, of course, other various functions such as a sum, a multiple, or a weighted sum of the two similarities other than the above Equation 3 may be used.

In the selecting step (S224), the combination data of the drug and the protein is selected based on the calculated correlation. Herein, in the selecting step (S224), combination data having the highest correlation with the combination data included in the test set may be selected and sorted in the training set. Alternatively, in the selecting step (S224), a plurality of combination data may be selected in the training set based on the correlation. For example, according to a comparison result obtained by comparing the correlation with a predetermined threshold, the combination data may be selected or the combination data having a high correlation with a predetermined ratio may also be selected.

Next, in the classifier parameter training step (S230), the parameter of the classifier may be trained based on the protein feature information and the drug feature information of each of the combination data of the drug and the protein selected in the training set and the combination data of the drug and the protein included in the test set. That is, in the classifier parameter training step (S230), the classifier is trained by using the combination data of the drug and the protein selected in the training set and the combination data of the test set based on the calculated correlation, and the parameter of the classifier inputting the protein feature information and the drug feature information of the combination data and outputting the correlation between the drug and the protein of the test set may be trained.

Alternatively, the classifier may be a classifier receiving a value calculating the similarity for each feature information between the protein feature information and the drug feature information of the combination data of the drug and the protein selected in the training set and the protein feature information and the drug feature information of the combination data of the drug and the protein included in the test set. In this case, in the classifier parameter training step (S230), the parameter of the classifier which inputs the values calculating the similarity for each feature information may be trained. Herein, at least one of the similarity between the chemical structure information of the drugs and the similarity between the side-effect information of the drugs may be used as the similarity between the drug feature information between the two combination data.

At least one of the similarity between the protein location information, the similarity between the amino acid sequence information of the protein, and the similarity between the location information on the PPI network may be used as the similarity between the protein feature information between the two combination data.

In this case, an incorrect set may be used for training the classifier, and the incorrect set may be combination data between the protein and the drug without the correlation. For example, the randomly combined combination data between the protein and the drug may be used as an incorrect set.

In the classifier parameter training step (S230), partial classifiers having the number of test sets set in the set setting step (S210) are trained by using the test set and the training set, respectively and thus, the classifier including the partial classifier may be trained. In the set setting step (S210), when a combination of total K test sets and training sets is set, partial classifiers for each set of the test set and the training set may be defined and trained. That is, a total of K partial classifiers may be trained.

In this case, in the process of training the parameter of the partial classifier, classification accuracy of each partial classifier may be measured. In addition, classification accuracy may be stored for each of the K partial classifiers.

Next, a method for analyzing a relation between a drug and a protein according to yet another exemplary embodiment of the present invention will be described. Yet another exemplary embodiment of the present invention relates to a method of determining the correlation with a drug and a protein which do not know the interrelation by using the classifier trained as described above.

The method for analyzing the relation between the drug and the protein according to yet another exemplary embodiment of the present invention may include a drug-protein feature information inputting step (S1000) and a correlation determining step (S2000).

FIG. 6 is a flowchart of a method for analyzing a relation between a drug and a protein according to yet another exemplary embodiment of the present invention. In the drug-protein feature information inputting step (S1000), with respect to a drug and a protein to determine the correlation, the drug feature information of the drug and the protein feature information of the protein are inputted.

In the correlation determining step (S2000), the correlation between the drug and the protein is determined based on the drug feature information and the protein feature information using the pre-trained classifier.

First, an operation of the drug-protein feature information inputting step (S1000) will be described in more detail.

In the drug-protein feature information inputting step (S1000), with respect to the drug and the protein to determine the correlation, the drug feature information of the drug and the protein feature information of the protein are inputted. Herein, the drug feature information and the protein feature information are feature information of the same content as the content described in the above protein location information inputting step (S100). As a result, the drug feature information and the protein feature information will be briefly described based on the gist.

First, the protein feature information includes protein location information representing a location where the protein is present in a cell and may include at least one of amino acid sequence information of the protein and location information on the PPI network together with the protein location information. In this case, the protein location information may include a protein location information vector representing whether the protein is present in at least one predetermined representative location in the cell. Herein, the representative location may include at least one of for example, cytosol, endoplasmic reticulum (ER), extracellular, Golgi, peroxisome, mitochondria, nucleus, lysosome, plasma membrane, or other locations. The protein location information vector may be a vector of which an element value of the vector is set as a predetermined first value when the protein is present at the representative location and the element value of the vector is set as a predetermined second value when the protein is not present at the representative location. Further, the drug feature information may include at least one of chemical structure information of the drug and side-effect information of the drug.

In the drug and protein feature information inputting step (S1000), each feature information of the drug and the protein to determine the correlation is inputted. Herein, receiving the information includes receiving information through an input/output interface. Alternatively, the receiving of the information is a concept including all operations of reading the stored information from a memory or a storage device or a server or a database connected to a network, and a concept including a series of operations of receiving the information in which other processors or a signal processing module or a hardware device is stored in the storage.

Next, the correlation determining step (S2000) will be described in more detail.

In the correlation determining step (S2000), the correlation between the drug and the protein is determined based on the drug feature information and the protein feature information using the pre-trained classifier. Herein, the classifier may be a classifier trained according to a method described with reference to FIGS. 1 to 5.

To this end, the correlation determining step (S2000) may include a drug-protein combination data selecting step (S2100) and a correlation determining step (S2200).

FIG. 7 is a detailed flowchart of the correlation determining step (S2000).

In the drug-protein combination data selecting step (S2100), in a correct set including combination data between a drug and a protein which are previously known to have the correlation, combination data between the drug and the protein to determine the correlation and combination data between the drug and the protein having a predetermined level or more of correlation are selected.

Herein, the correct set is a set of the combination data between the drug and the protein which are known to have the correlation, and for example, a training data set which has been used in the method described with reference to FIGS. 1 to 5 may be used as the correct set.

Herein, in the drug-protein combination data selecting step (S2100), the combination data of the drug and the protein is selected based on the correlation by the same method as the selecting step (S220) described with reference to FIG. 3. Herein, the training set becomes a correct set and the combination data included in the test set becomes combination data between the drug and the protein to determine the correlation. In other parts, the drug-protein combination data selecting step (S2100) may operate the same as the selecting step (S220) described with reference to FIG. 3. As a result, the drug-protein combination data selecting step (S2100) will be briefly described based on the gist.

Herein, the drug-protein combination data selecting step (S2100) may include a drug-drug similarity calculating step (not illustrated), a protein-protein similarity calculating step (not illustrated), a correlation calculating step (not illustrated), and a selecting step (not illustrated).

In the drug-drug similarity calculating step (not illustrated), the similarity between the drug feature information of the combination data of the drug and the protein to determine the correlation and the drug feature information of the combination data of the drug and the protein included in the correct set is calculated. That is, the drug-drug similarity is calculated between the combination data to determine the correlation and the combination data of the correct set, and in this case, the drug-drug similarity may be similarity between drug feature information.

In the protein-protein similarity calculating step (not illustrated), the similarity between the protein feature information of the combination data of the drug and the protein to determine the correlation and the protein feature information of the combination data of the drug and the protein included in the correct set is calculated. That is, the protein-protein similarity is calculated between the combination data to determine the correlation and the combination data of the correct set, and in this case, the protein-protein similarity may be similarity between the protein feature information. Herein, the similarity between the protein feature information may be calculated by using at least one of the similarity between the protein location information, the similarity between the amino acid sequence information of the protein, and the similarity between the location information on the PPI network. Herein, the method of calculating the similarity between the protein location information, the similarity between the amino acid sequence information of the protein, and the similarity between the location information on the PPI network may use known methods. For example, the similarity between the protein location information may be calculated by a distance between the protein location information vectors. Alternatively, cosine similarity between the protein location information vectors may be calculated. For example, the similarity between the location information on the PPI network may be calculated by a distance between the protein nodes. That is, the similarity may be calculated by a distance between the nodes on the network.

In the correlation calculating step (not illustrated), the correlation is calculated by using the calculated similarity between the drug feature information and the similarity between the protein feature information. Herein, the correlation as an index representing a degree associated between the combination data may be a value calculated by calculating the similarity between the drug feature information and the similarity between the protein feature information. In this case, as an operational function calculating the correlation, various functions in which values are changed according to a size of the two similarity values may be set.

In the selecting step (not illustrated), the combination data of the drug and the protein is selected based on the calculated correlation. Herein, in the selecting step, combination data having the highest correlation with the combination data to determine the correlation may be selected and sorted in the correct set. Alternatively, in the selecting step, a plurality of combination data may be selected in the correct set based on the correlation. For example, according to a comparison result obtained by comparing the correlation with a predetermined threshold, the combination data may be selected or the combination data having a high correlation with a predetermined ratio may also be selected.

In the correct set through the above process, the combination data between the drug and the protein having a predetermined level or more of correlation with the combination data between the drug and the protein to determine the correlation may be selected.

Next, in the correlation determining step (S2200), the correlation between the drug and the protein is determined by using the classifier based on the protein feature information and the drug feature information of each of the combination data between the drug and the protein selected in the correct set and the combination data between the drug and the protein to determine the correlation.

Herein, the classifier may use the drug feature information and the protein feature information for the target drug and the protein to determine the correlation and the drug feature information and the protein feature information of the selected combination data of the drug and the protein as input information. Alternatively, the classifier may calculate similarity for each feature information between the drug feature information and the protein feature information for the target drug and the protein and the drug feature information and the protein feature information of the selected combination data of the drug and the protein and determine a correlation between the target drug and the protein by inputting the calculated similarity to the classifier.

Herein, at least one of the similarity between the chemical structure information of the drugs and the similarity between the side-effect information of the drugs may be used as the similarity between the drug feature information between the two combination data. Further, at least one of the similarity between the protein location information, the similarity between the amino acid sequence information of the protein, and the similarity between the location information on the PPI network may be used as the similarity between the protein feature information between the two combination data.

Herein, the classifier may be a classifier trained by using a machine training algorithm based on the aforementioned input information. Further, herein, the correlation determined by the classifier may be an index which represents whether the specific drug and the protein have a correlation or not as TRUE or FALSE. Alternatively, if necessary, the correlation may be an index expressed by a value having a predetermined range representing the correlation between the specific drug and the protein. Herein, the classifier may also output the correlation to have a value of 1 (there is a correlation) or 0 (there is no correlation) according to an operation of a classification function of the classifier, or output the correlation to have a large value as the correlation is increased in a range of 0 to 1.

Herein, the classifier may be a classifier trained based on the k-fold Cross Validation method as described above. In this case, the classifier may include a plurality (for example, K) of partial classifiers trained according to the number (for example, K) of sets of test sets and training sets used in the training process. As such, in the case of using the partial classifiers, a correlation value for each partial classifier may be output according to the input value of the classifier described above, that is, the feature information or the similarity. In this case, whether a correlation between the target drug and the protein is present may be finally determined by integrating correlation values outputted from each of the partial classifiers. Herein, various known methods of determining the final classification result value may be used by using the plurality of partial classifiers. For example, the final correlation value may be determined by summing all of the output correlation values of the partial classifiers. Alternatively, a value obtained by multiplying classification accuracy of the corresponding partial classifier by a weighted value with the correlation value output in each partial classifier and weighted-summing the value may be calculated as the final correlation value.

Next, an apparatus for analyzing a relation between a drug and a protein according to still another exemplary embodiment of the present invention will be described.

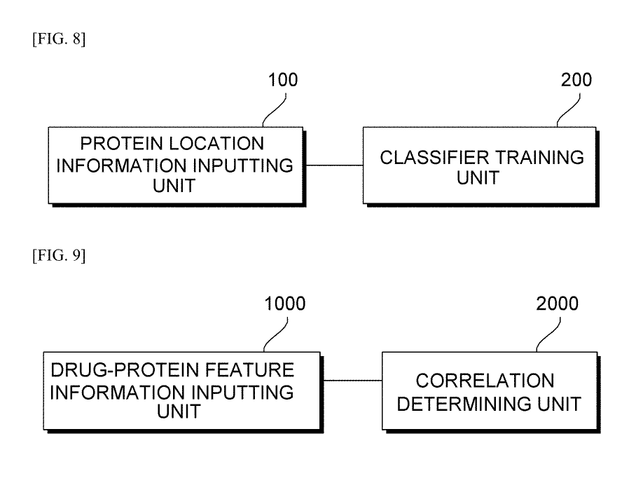

FIG. 8 is a block diagram of an apparatus for analyzing a relation between a drug and a protein according to still another exemplary embodiment of the present invention.

The apparatus for analyzing a relation between a drug and a protein according to still another exemplary embodiment of the present invention may include a protein location information inputting unit 100 and a classifier training unit 200. The exemplary embodiment of the present invention relates to an apparatus for training the classifier used for analyzing the relation between the drug and the protein. Herein, the apparatus for analyzing the relation between the drug and the protein according to the exemplary embodiment may operate by the same method as the method for analyzing the relation between the drug and the protein according to the present invention described in detail with reference to FIGS. 1 to 5. Accordingly, the duplicated part will be omitted or briefly described.

The protein location information inputting unit 100 receives the protein location information representing a location where the protein included in a training data set is present in a cell, with regard to the training data set including at least one combination data of the drug and the protein having interrelation.

The classifier training unit 200 trains the classifier for determining a correlation between the drug and the protein by using the training data set based on protein feature information of the protein including the protein location information and drug feature information of the drug.

Herein, the apparatus for analyzing the relation between the drug and the protein according to still another exemplary embodiment of the present invention may further include a protein information updating unit (not illustrated) based on a protein-protein interaction network. The protein information updating unit (not illustrated) based on a protein-protein interaction network updates the protein location information of the protein included in the training data set by using the protein-protein interaction network representing the relation between the proteins. In this case, the classifier training unit 200 may train the classifier based on the protein feature information according to the updated protein location information.

An apparatus for analyzing a relation between a drug and a protein according to still yet another exemplary embodiment of the present invention may include a drug-protein feature information inputting unit 1000 and a correlation determining unit 2000.

FIG. 9 is a block diagram of an apparatus for analyzing a relation between a drug and a protein according to still yet another exemplary embodiment of the present invention.

Still yet another exemplary embodiment of the present invention relates to an apparatus of determining the correlation with a drug and a protein which do not know the interrelation by using the classifier trained as described above. Herein, the apparatus for analyzing the relation between the drug and the protein according to the exemplary embodiment may operate by the same method as the method for analyzing the relation between the drug and the protein according to the present invention described in detail with reference to FIGS. 5 and 6. Accordingly, the duplicated part will be omitted or briefly described.

The drug-protein feature information inputting unit 1000 receives the drug feature information of the drug and the protein feature information of the protein with respect to the drug and the protein to determine the correlation.

The correlation determining unit 2000 determines the correlation between the drug and the protein based on the drug feature information and the protein feature information using the pre-trained classifier.

Herein, the protein feature information includes protein location information representing a location where the protein is present in a cell.

Herein, the correlation determining unit 2000 may include a drug-protein combination data selecting unit 2100 and a correlation determining unit 2200.

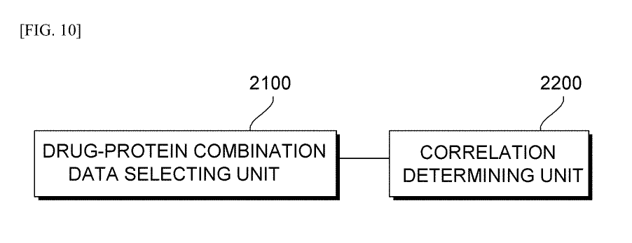

FIG. 10 is a detailed block diagram of the correlation determining unit 2000.

The drug-protein combination data selecting unit 2100 selects combination data between the drug and the protein to determine the correlation and combination data between the drug and the protein having a predetermined level or more of correlation in a correct set including combination data between a drug and a protein which are previously known to have the correlation.

The correlation determining unit 2200 determines the correlation between the drug and the protein by using the classifier based on the protein feature information and the drug feature information of each of the combination data between the drug and the protein selected in the correct set and the combination data between the drug and the protein to determine the correlation.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for analyzing a relation between a drug and a protein, comprising:
a protein location information inputting step of receiving a protein location information representing a location where the protein included in a training data set is present in a cell, with regard to the training data set including at least one combination data of the drug and the protein having interrelation; and
a classifier training step of training the classifier for determining a correlation between the drug and the protein by using the training data set based on protein feature information of the protein including the protein location information and drug feature information of the drug.

2. The method for analyzing the relation between the drug and the protein of claim 1, wherein the classifier is a classifier that determines the correlation between the protein and the drug by inputting the protein feature information of the protein and the drug feature information of the drug.

3. The method for analyzing the relation between the drug and the protein of claim 1, further comprising:
a protein location information updating step based on the protein-protein interaction network of updating the protein location information of the protein included in the training data set by using the protein-protein interaction network representing the relation between the proteins,
wherein in the classifier training step, the classifier is trained based on the protein feature information according to the updated protein location information.

4. The method for analyzing the relation between the drug and the protein of claim 1, wherein the protein location information includes a protein location information vector representing whether the protein is present in at least one predetermined representative location in a cell.

5. The method for analyzing the relation between the drug and the protein of claim 4, wherein the representative location includes at least one of cytosol, endoplasmic reticulum, extracellular, Golgi, peroxisome, mitochondria, nucleus, lysosome, and plasma membrane.

6. The method for analyzing the relation between the drug and the protein of claim 1, wherein the protein feature information includes at least one of amino acid sequence information of the protein and location information on the protein-protein interaction network, together with the protein location information.

7. The method for analyzing the relation between the drug and the protein of claim 1, wherein the drug feature information includes at least one of chemical structure information of the drug and side-effect information of the drug.

8. The method for analyzing the relation between the drug and the protein of claim 1, wherein the classifier training step includes:
a set setting step of setting a test set and a training set in the training data set;
a selecting step of selecting combination data of the drug and the protein having a predetermined level or more of correlation with the combination data of the drug and the protein included in the test set from the combination data of the drug and the protein included in the training set, for each combination data of the drug and the protein included in the test set; and
a classifier parameter training step of training a parameter of the classifier based on the protein feature information and the drug feature information of each of the combination data of the drug and the protein selected in the training set and the combination data of the drug and the protein included in the test set.

9. The method for analyzing the relation between the drug and the protein of claim 8, wherein in the set setting step, the training data set is divided into a predetermined number of partial sets and some of the divided partial sets are set to the test set and the remaining partial sets except for the test set are set to the training set.

10. The method for analyzing the relation between the drug and the protein of claim 8, wherein the selecting step includes:
a drug-drug similarity calculating step of calculating the similarity between the drug feature information of the combination data of the drug and the protein included in the test set and the drug feature information of the combination data of the drug and the protein included in the training set;
a protein-protein similarity calculating step of calculating the similarity between the protein feature information of the combination data of the drug and the protein included in the test set and the protein feature information of the combination data of the drug and the protein included in the training set;
a correlation calculating step of calculating the correlation by using the calculated similarity between the drug feature information and the similarity between the protein feature information; and
a selecting step of selecting the combination data of the drug and the protein based on the calculated correlation.

11. The method for analyzing the relation between the drug and the protein of claim 8, wherein in the classifier parameter training step, the classifier including the partial classifiers is trained by training the partial classifiers having the number of test sets set in the set setting step by using the test set and the training set.

12. The method for analyzing the relation between the drug and the protein of claim 3, wherein in the protein location information updating step based on the protein-protein interaction network, the protein location information of the protein of the protein-protein interaction network is updated by using and calculating the protein location information of adjacent proteins connected to the protein in the protein-protein interaction network.

13. The method for analyzing the relation between the drug and the protein of claim 12, wherein in the protein location information updating step based on the protein-protein interaction network, the protein location information of the protein of which the protein location information is set in the early stages is maintained in the protein-protein interaction network, and the protein location information of the protein of which the protein location information is not set in the early stages is set as the protein location information calculated by using the adjacent protein.

14. A method for analyzing a relation between a drug and a protein, comprising:
a drug-protein feature information inputting step of receiving the drug feature information of the drug and the protein feature information of the protein, with respect to the drug and the protein to determine a correlation; and
a correlation determining step of determining the correlation between the drug and the protein based on the drug feature information and the protein feature information using the pre-trained classifier,
wherein the protein feature information includes protein location information representing a location where the protein is present in a cell.

15. The method for analyzing the relation between the drug and the protein of claim 14, wherein the protein location information includes a protein location information vector representing whether the protein is present in at least one predetermined representative location in a cell.

16. The method for analyzing the relation between the drug and the protein of claim 14, wherein the protein feature information includes at least one of amino acid sequence information of the protein and location information on the protein-protein interaction network, together with the protein location information, and
the drug feature information includes at least one of chemical structure information of the drug and side-effect information of the drug.

17. The method for analyzing the relation between the drug and the protein of claim 14, wherein the correlation determining step includes:
a selecting step of selecting combination data between the drug and the protein to determine the correlation and combination data between the drug and the protein having a predetermined level or more of correlation, in a correct set including combination data between a drug and a protein which are previously known to have the correlation; and
a determining step of determining the correlation between the drug and the protein by using the classifier based on the protein feature information and the drug feature information of each of the combination data between the drug and the protein selected in the correct set and the combination data between the drug and the protein to determine the correlation.
